(19) United States
(12) Patent Application Publication
(10) Pub. No.: US 2026/0098199 A1
(43) Pub. Date: Apr. 9, 2026

(54) URETHANE FOAM MOLDED BODY

(71) Applicant: Sumitomo Riko Company Limited, Aichi (JP)

(72) Inventors: Takahisa Kose, Aichi (JP); Junichiro Suzuki, Aichi (JP); Koji Mizutani, Aichi (JP); Junki Owaki, Aichi (JP)

(73) Assignee: Sumitomo Riko Company Limited, Aichi (JP)

(21) Appl. No.: 19/409,784

(22) Filed: Dec. 5, 2025

Related U.S. Application Data
(63) Continuation of application No. PCT/JP2024/011359, filed on Mar. 22, 2024.

(30) Foreign Application Priority Data
Jun. 30, 2023 (JP) 2023-108061

(51) Int. Cl. C09K 5/14; C08K 3/22; C08K 9/08

(52) U.S. Cl. CPC C09K 5/14; C08K 3/22; C08K 9/08; C08K 2003/222; C08K 2003/2227; C08K 2201/001; C08K 2201/003; C08K 2201/005; C08K 2201/01

(57) ABSTRACT

A urethane foam molded body includes a base material made of polyurethane foam, composite particles contained in an oriented manner in the base material, and first insulating inorganic particles dispersed in the base material. The composite particles include thermally conductive particles and magnetic particles bonded to the surface of the thermally conductive particles by a binder. The first insulating inorganic particles include large diameter particles having a median diameter of 55 μm or more and 200 μm or less.

### CROSS-REFERENCE TO RELATED APPLICATION

This application is a continuation of PCT International Application No. PCT/JP2024/011359, filed on Mar. 22, 2024, which claims priority under 35 U.S.C § 119(a) to Japanese Patent Application No. 2023-108061, filed on Jun. 30, 2023. Each of the above application(s) is hereby expressly incorporated by reference, in its entirety, into the present application.

### BACKGROUND

### Technical Field

The disclosure relates to a urethane foam molded body having high thermal conductivity.

### Description of Related Art

In vehicles such as automobiles, measures are taken to reduce noise generated from engines, transmissions, and the like in order to reduce noise leaking to the outside of the vehicle or into the vehicle cabin. In electric vehicles (EV) and hybrid electric vehicles (HEV), driving noise from electric powertrains consisting of inverters, motors, gearboxes, and the like is also a target for reduction. As a noise countermeasure, for example, soundproofing materials made of foam such as polyurethane foam are used. Since foam has multiple cells (air bubbles) inside, the thermal conductivity is low. Therefore, in the case of being disposed around noise sources that generate heat, heat may accumulate and cause malfunctions.

From the viewpoint of improving the heat dissipation of soundproofing materials using foam, for example, Patent Literature 1 (International Publication No. WO 2013/042611) describes a urethane foam molded body in which composite particles, which are composites of thermally conductive particles, magnetic particles, and insulating inorganic particles, are oriented and disposed in polyurethane foam to form heat transmission paths in the orientation direction, thereby improving heat dissipation. The same literature also describes that by dispersing insulating inorganic particles separately from the composite particles in polyurethane foam, electrical insulation can be imparted, and heat dissipation and flame retardancy can be improved according to the characteristics of the insulating inorganic particles.

However, conventional urethane foam molded bodies have low heat resistance, specifically, physical properties such as elongation deteriorate in the case of being placed under high temperatures of about 150° C. In the case of low heat resistance, conventional urethane foam molded bodies are difficult to be applied to components that become high temperature, such as various electronic control units (ECU) and junction boxes mounted on vehicles. In the above Patent Literature 1, merely the thermal conductivity and electrical insulation of the urethane foam molded body are evaluated, and heat resistance is not examined.

The disclosure provides a urethane foam molded body exemplary in thermal conductivity and heat resistance.

### SUMMARY

(1) The urethane foam molded body of the disclosure includes a base material made of polyurethane foam, composite particles contained in an oriented manner in the base material, and first insulating inorganic particles dispersed in the base material. The composite particles include thermally conductive particles and magnetic particles bonded to a surface of the thermally conductive particles by a binder, and the first insulating inorganic particles include large diameter particles having a median diameter of 55 μm or more and 200 μm or less.

The urethane foam molded body of the disclosure includes the composite particles disposed in an oriented manner in the base material and the first insulating inorganic particles dispersed in the base material. The composite particles having thermally conductive particles as cores are connected in a bead-like manner, thereby forming heat transmission paths in the base material. In this way, desired thermal conductivity may be achieved. The first insulating inorganic particles are particles of an insulating inorganic material. The presence of the first insulating inorganic particles makes it difficult for the composite particles to conduct with each other, thereby improving the electrical insulation of the urethane foam molded body. In addition, in the case of the first insulating inorganic particles having relatively high thermal conductivity, heat transmission paths by the first insulating inorganic particles are also formed in addition to the heat transmission paths by the composite particles. This further improves the thermal conductivity of the urethane foam molded body. In addition, in the case of the first insulating inorganic particles having flame retardancy, the flame retardancy of the urethane foam molded body is improved.

As described in paragraph of the above Patent Literature 1, “The size of the insulating inorganic particles dispersed in the base material is desirably (omitted) a median diameter of 1 μm or more and 20 μm or less,” relatively small diameter particles are used as the insulating inorganic particles to be dispersed in polyurethane foam in consideration of the influence on the foaming and curing reaction and the like. In the case of the insulating inorganic particles having a small particle diameter, the specific surface area becomes large, and the contact area with the polyurethane foam as the base material becomes large. The present inventors focused on the insulating inorganic particles and conducted repeated studies, and as a result, found that in the case of the contact area between the insulating inorganic particles and the polyurethane foam being large, the influence of the insulating inorganic particles becomes large, which is one factor that reduces the heat resistance of the urethane foam molded body. For example, in the case of the insulating inorganic particles being particles that react with water to exhibit alkalinity, in response to the insulating inorganic particles reacting with water contained in the polyurethane foam, an alkaline atmosphere is generated. In the case of being exposed to high temperature in the state, it is presumed that hydrolysis of the polyurethane is promoted and deterioration progresses.

According to the urethane foam molded body of the disclosure, the first insulating inorganic particles dispersed in the base material have large diameter particles with a median diameter of 55 μm or more and 200 μm or less. Therefore, compared to the case of using small diameter particles, the contact area between the first insulating inorganic particles and the polyurethane foam becomes smaller, and the influence of the first insulating inorganic particles can be reduced. Thus, even in the case of the urethane foam molded body being placed under high temperature, deterioration of the polyurethane can be suppressed, and reduction in physical properties such as elongation can be suppressed. On the other hand, in the case of the particles dispersed in the base material being too large, deterioration in moldability and physical properties is caused. Regarding this point, by setting the upper limit of the median diameter of the large diameter particles to 200 μm, the influence on moldability is reduced, and generation of cracks and the like is suppressed. As a result, desired physical properties such as elongation can be maintained. From the above, the urethane foam molded body of the disclosure excels in thermal conductivity and heat resistance.
(2) In the above configuration, the content of the first insulating inorganic particles may be 5 volume % or more and 20 volume % or less in the case of the volume of the urethane foam molded body being 100 volume %. According to the configuration, effects such as imparting electrical insulation and improving thermal conductivity by the first insulating inorganic particles can be obtained while reducing the influence on the foaming and curing reaction and moldability.
(3) In any of the above configurations, the thermal conductivity of the first insulating inorganic particles may be 5 W/m·K or higher. According to the configuration, the effect of improving thermal conductivity by the first insulating inorganic particles can be obtained.
(4) In any of the above configurations, the first insulating inorganic particles may have a configuration including one or more types selected from aluminum hydroxide, aluminum oxide, aluminum nitride, magnesium hydroxide, magnesium oxide, talc, calcium carbonate, clay, mica, and silica. The first insulating inorganic particles of the configuration are relatively inexpensive and easily available. Among these, aluminum hydroxide, aluminum oxide, aluminum nitride, magnesium hydroxide, magnesium oxide, and talc are suitable for enhancing the thermal conductivity of the urethane foam molded body because of having relatively high thermal conductivity.
(5) In any of the above configurations, the large diameter particles may have a configuration of being particles that react with water to exhibit alkalinity. “Particles that react with water to exhibit alkalinity” refers to particles that result in a pH greater than 7 in the case of measuring the pH of a dispersion in which 2 g of powder of target particles is dispersed in 50 mL of ion-exchanged water at room temperature (20° C.±5° C., the same applies hereinafter). Particles that react with water to exhibit alkalinity (hereinafter, may be referred to as “alkaline inorganic particles”) react with water contained in the polyurethane foam of the base material to generate an alkaline atmosphere, which may promote hydrolysis of the polyurethane. Therefore, in the case of using alkaline inorganic particles as the first insulating inorganic particles, by increasing the particle diameter of the particles, specifically by setting the median diameter to 55 μm or more and 200 μm or less, the contact area between the alkaline inorganic particles and the polyurethane foam becomes smaller, and hydrolysis of the polyurethane can be suppressed. Thus, the configuration is effective for improving the heat resistance of the urethane foam molded body.
(6) In any of the above configurations, the thermally conductive particles may have a configuration including expanded graphite particles. Expanded graphite particles are formed by inserting a substance that generates gas by heating between layers of flake-like graphite. In response to heat being applied to the expanded graphite particles, the generated gas causes the interlayers to expand and forms layers that are stable against heat and chemicals. The formed layers become heat insulating layers and provide a flame retardant effect by preventing heat transfer.

Usually, urethane foam molded bodies that are provided with flame retardancy have a dropping action that suppresses fire spread by dropping fire sources even in response to being exposed to flames. However, in the case of magnetic particles being blended, the dropping action may be impaired and the self-extinguishing property of the urethane foam molded body may deteriorate. In the urethane foam molded body of the disclosure, the composite particles are oriented. Therefore, heat applied to the urethane foam molded body is easily transmitted to the thermally conductive particles, and the expanded graphite particles quickly reach the expansion initiation temperature. As a result, the flame retardant effect by the expanded graphite particles is promptly exhibited. Therefore, according to the configuration, deterioration of the self-extinguishing property of the urethane foam molded body can be suppressed, and flame retardancy can be maintained.
(7) In any of the above configurations, the composite particles may have a configuration including second insulating inorganic particles bonded to the surface of the thermally conductive particles by a binder. In the configuration, the second insulating inorganic particles may be directly bonded to the surface of the thermally conductive particles serving as cores, or may be indirectly bonded via the magnetic particles. As the magnetic particles, ferromagnetic materials such as stainless steel and iron are used. Therefore, the composite particles in which the thermally conductive particles and the magnetic particles are composited have high conductivity. In response to the second insulating inorganic particles being bonded to the composite particles in this state, even according to the composite particles being oriented in a state of contact with each other, the thermally conductive particles and magnetic particles (conductive particles) become less likely to contact each other between the adjacent composite particles. Therefore, the electrical resistance between the composite particles increases. Additionally, according to the composite particles contacting each other via the second insulating inorganic particles, conduction between the composite particles can be cut off. As a result, in the urethane foam molded body of the disclosure, desired electrical insulation can be achieved. Thus, according to the configuration, electrical insulation can be provided in addition to high thermal conductivity and heat resistance. Therefore, the urethane foam molded body of the configuration is also suitable for applications requiring both heat dissipation and electrical insulation, such as heat dissipation members in electronic devices.
(8) In the configuration of (7) above, the particle diameter of the second insulating inorganic particles may be 1/10 or less of the particle diameter of the thermally conductive particles, and the median diameter may be 1 μm or more and 20 μm or less. In the case of the second insulating inorganic particles being too large, the adhesion to the thermally conductive particles and the thermal conductivity between the composite particles decrease. In addition, since the second insulating inorganic particles are bonded to the thermally conductive particles and are merely a part of the composite particles, the contact area with the polyurethane foam of the base material is small, and the influence on the polyurethane foam is small. Therefore, according to the configuration, composite particles having good adhesion of the second insulating inorganic particles can be achieved, and good thermal conductivity between the composite particles can be maintained.
(9) In the configuration of (7) or (8) above, the second insulating inorganic particles may have a configuration including one or more types selected from aluminum hydroxide, aluminum oxide, aluminum nitride, magnesium hydroxide, magnesium oxide, talc, calcium carbonate, clay, mica, and silica. As described in the configuration of (4) above, the second insulating inorganic particles of the configuration are relatively inexpensive and easily available. Among these, talc and mica are flake-shaped and excel in coverage properties. In addition, aluminum hydroxide, aluminum oxide, aluminum nitride, magnesium hydroxide, magnesium oxide, and talc have relatively high thermal conductivity, and therefore are less likely to inhibit the thermal conductivity between the composite particles.

### DESCRIPTION OF EMBODIMENTS

In the base material of the urethane foam molded body of the disclosure, composite particles having thermally conductive particles as cores are oriented, and first insulating inorganic particles are dispersed. The first insulating inorganic particles have large diameter particles with a median diameter of 55 μm or more and 200 μm or less. By using the large diameter particles, the contact area between the first insulating inorganic particles and the base material becomes small, and the influence of the first insulating inorganic particles on the polyurethane can be reduced. Thus, even in the case of the urethane foam molded body being placed under high temperature, deterioration of the polyurethane can be suppressed, and reduction in physical properties such as elongation can be suppressed. Therefore, the urethane foam molded body of the disclosure excels in thermal conductivity and heat resistance.

Hereinafter, embodiments of a urethane foam molded body of the disclosure will be described. Note that the embodiments are not limited to the following forms, and can be implemented in various modification examples and improved forms that can be performed by those skilled in the art.

### <Urethane Foam Molded Body>

The urethane foam molded body of the disclosure includes a base material made of polyurethane foam, composite particles contained in an oriented manner in the base material, and first insulating inorganic particles dispersed in the base material.

### [Base Material]

The polyurethane foam of the base material is manufactured from foamed urethane resin raw materials such as polyisocyanate components and polyol components. The foamed urethane resin raw material may be prepared from already known raw materials such as polyol and polyisocyanate. The polyol may be appropriately selected from polyhydroxy compounds, polyether polyols, polyester polyols, polymer polyols, polyether polyamines, polyester polyamines, alkylene polyols, urea-dispersed polyols, melamine-modified polyols, polycarbonate polyols, acrylic polyols, polybutadiene polyols, phenol-modified polyols, and the like. Further, the polyisocyanate may be appropriately selected from, for example, tolylene diisocyanate, phenylene diisocyanate, xylylene diisocyanate, diphenylmethane diisocyanate, triphenylmethane triisocyanate, polymethylene polyphenyl isocyanate, naphthalene diisocyanate, and derivatives thereof (for example, prepolymers obtained by reaction with polyols, modified polyisocyanates), and the like.

The foamed urethane resin raw material may further appropriately include a catalyst, foaming agent, foam stabilizer, plasticizer, crosslinking agent, chain extender, flame retardant, antistatic agent, viscosity reducer, stabilizer, filler, colorant, and the like. For example, as the catalyst, amine-based catalysts such as tetraethylenediamine, triethylenediamine, and dimethylethanolamine, and organometallic catalysts such as tin laurate and tin octoate can be mentioned. Further, water is suitable as the foaming agent. Other than water, methylene chloride, fluorocarbons, CO₂ gas, and the like can be mentioned. Further, silicone-based foam stabilizers are suitable as the foam stabilizer, and triethanolamine, diethanolamine, and the like are suitable as the crosslinking agent.

The shape, size, and the like of the base material are not particularly limited and may be appropriately determined according to the application. The composite particles contained in the base material may be disposed with a certain regularity. For example, the composite particles may be disposed linearly or in a curved manner between one end and the other end of the urethane foam molded body (the other end does not need to be an end portion facing 180° opposite to the one end). Further, the composite particles may be disposed radially from the center toward the outer periphery.

### [Composite Particles]

The composite particles contained in an oriented manner in the base material are particles in which magnetic particles and the like are bonded to the surface of thermally conductive particles serving as cores by a binder. The thermally conductive particles may be non-magnetic materials having high thermal conductivity. In the present specification, diamagnetic materials and paramagnetic materials other than ferromagnetic materials and antiferromagnetic materials are referred to as non-magnetic materials. For example, the thermal conductivity of the thermally conductive particles is desirably 200 W/m·K or higher. Examples of the material of the thermally conductive particles include carbon materials such as graphite and carbon fiber. Further, aluminum, gold, silver, copper, and alloys having these as base materials may also be used. The thermally conductive particles may be single particles or aggregate particles in which multiple particles are integrated.

The shape of the thermally conductive particles is not particularly limited as long as they can be composited with other particles such as magnetic particles. For example, various shapes such as flake-shaped, fibrous, columnar, spherical, ellipsoidal, and prolate spheroidal (a shape in which a pair of opposing hemispheres are connected by a cylinder) can be adopted. In the case of thermally conductive particles having shapes other than spherical, the contact area between the composite particles becomes large. This makes it easier to secure transmission paths for heat and also increases the amount of heat transmitted. For example, graphite particles can be obtained at low cost compared to metal particles even when graphite particles have shapes with large aspect ratios. For this reason, graphite particles are suitable as thermally conductive particles. Examples of graphite include natural graphite such as flake-like graphite, scale graphite, and earthy graphite, and artificial graphite. Artificial graphite does not easily become flake-like. For this reason, natural graphite is suitable because it is flake-like and has a high effect of improving thermal conductivity. Further, as graphite, expanded graphite in which a substance that generates gas by heating is inserted between layers of flake-like graphite may be used. In response to heat being applied to expanded graphite, the generated gas causes the interlayers to expand and forms layers that are stable against heat and chemicals. The stable layers become heat insulating layers and provide a flame retardant effect by preventing heat transfer. Therefore, considering flame retardancy, expanded graphite particles are suitable as thermally conductive particles. The expanded graphite particles may be appropriately selected in consideration of the expansion initiation temperature, expansion ratio, and the like. Since the expansion initiation temperature has to be higher than the heat generation temperature during molding of the urethane foam molded body, expanded graphite particles having an expansion initiation temperature of 150° C. or higher are suitable.

The median diameter of the thermally conductive particles is desirably 100 μm or more from the viewpoint of increasing thermal conductivity. 700 μm or more is more suitable. On the other hand, in the case of the thermally conductive particles being too large, the molded body may become brittle due to cracks starting from the particles. Therefore, the median diameter of the thermally conductive particles is desirably 3000 μm or less. 2000 μm or less is more suitable. The median diameter in the specification is a value (D₅₀) obtained from a volume-based particle size distribution measured by the laser diffraction/scattering method unless otherwise specified. For commercial products, catalog values may be adopted.

The magnetic particles need merely be capable of orienting the composite particles, and for example, ferromagnetic materials such as iron, nickel, cobalt, gadolinium, stainless steel, magnetite, maghemite, manganese zinc ferrite, barium ferrite, strontium ferrite, antiferromagnetic materials such as MnO, Cr₂O₃, FeCl₂, MnAs, and particles of alloys using these are suitable. Among these, iron, nickel, cobalt, and iron-based alloys thereof (including stainless steel) are suitable from the viewpoint of being easily available as fine particles and having high saturation magnetization. Iron in particular is relatively inexpensive and easily available, so manufacturing costs can be reduced, making it suitable for mass production.

The magnetic particles may be directly bonded to the surface of the thermally conductive particles, or may be indirectly bonded via second insulating inorganic particles described later. The magnetic particles may be bonded to merely a part of the surface of the thermally conductive particles, or may be bonded to cover the entire surface. The size of the magnetic particles may be appropriately determined in consideration of the size of the thermally conductive particles, the orientation of the composite particles, and the thermal conductivity between the composite particles. For example, the particle diameter of the magnetic particles is desirably 1/10 or less of the particle diameter of the thermally conductive particles. The “particle diameter” in this case is the equivalent spherical diameter by volume. According to the size of the magnetic particles becoming smaller, the saturation magnetization of the magnetic particles tends to decrease. Therefore, in order to orient the composite particles with a smaller amount of magnetic particles, it is desirable that the median diameter of the magnetic particles be 100 nm or more. 1 μm or more, and further 5 μm or more is more suitable.

The shape of the magnetic particles is not particularly limited. For example, in the case of the magnetic particles having a flat shape, the distance between adjacent thermally conductive particles becomes shorter compared to the case of a spherical shape. This improves the thermal conductivity between the adjacent composite particles. As a result, the thermal conductivity of the urethane foam molded body is improved. In the case of the magnetic particles having a flat shape, the magnetic particles and the thermally conductive particles contact each other at surfaces. That is, the contact area between both becomes large. This improves the bonding force between the magnetic particles and the thermally conductive particles. Therefore, the magnetic particles become difficult to peel off. In addition, the thermal conductivity between the magnetic particles and the thermally conductive particles is also improved. For such reasons, it is desirable to employ flake-shaped particles as the magnetic particles.

The content of the magnetic particles is desirably 20 mass % or more in the case of the mass of the thermally conductive particles in the base material being 100 mass %, from the viewpoint that the composite particles can be oriented even in a relatively low magnetic field. From the viewpoint of cost reduction and weight reduction, the content of the magnetic particles is desirably 130 mass % or less. 100 mass % or less, and further 80 mass % or less is more suitable.

The binder that bonds the thermally conductive particles and the magnetic particles may be appropriately selected in consideration of adhesiveness, influence on the foaming and curing reaction, and the like. Water-soluble polymers are suitable because of having little influence on the foaming and curing reaction and being environmentally friendly. For example, methylcellulose, carboxymethylcellulose, hydroxypropylmethylcellulose, polyvinyl alcohol, starch, and the like can be mentioned. Among these, starch is suitable because starch is relatively inexpensive, has high adhesiveness, and excels in granulation properties.

The thermally conductive particles and magnetic particles have conductivity. Therefore, according to the composite particles being arranged in a chain and oriented, a conduction path is formed in the base material. For example, the composite particles can be configured by bonding the second insulating inorganic particles to the surface of the thermally conductive particles with a binder in addition to the magnetic particles. By doing so, even in the case of the composite particles being oriented, the electrical resistance between the adjacent composite particles can be increased or conduction can be blocked. As a result, electrical insulation can be imparted to the urethane foam molded body.

The second insulating inorganic particles may be particles of an inorganic material having insulation properties, similar to the first insulating inorganic particles dispersed in the base material. Examples of the second insulating inorganic material include aluminum hydroxide, aluminum oxide, aluminum nitride, magnesium hydroxide, magnesium oxide, talc, calcium carbonate, clay, mica, silica, and the like. One type of these can be used alone, or two or more types can be used in combination. Among these, talc and mica are suitable because talc and mica are flake-shaped and excel in coverage properties. From the viewpoint of not inhibiting the thermal conductivity between the composite particles, those having a relatively large thermal conductivity may be adopted.

The second insulating inorganic particles may be directly bonded to the surface of the thermally conductive particles, or may be indirectly bonded via the magnetic particles or the like. The second insulating inorganic particles may be bonded to merely a part of the surface of the thermally conductive particles, or may be bonded so as to cover the entire surface. From the viewpoint of increasing the electrical resistance between the composite particles and enhancing the electrical insulation of the urethane foam molded body, it is desirable that the second insulating inorganic particles are disposed in the outermost layer of the composite particles. The binder that bonds the magnetic particles to the thermally conductive particles and the binder that bonds the insulating inorganic particles may be the same or different.

The size of the second insulating inorganic particles may be appropriately determined in consideration of the adhesion to the thermally conductive particles and magnetic particles, and the electrical insulation and thermal conductivity between the composite particles. In the case of the second insulating inorganic particles being too large, the adhesion and thermal conductivity between the composite particles decrease. For example, it is desirable that the particle diameter of the second insulating inorganic particles is 1/10 or less of the particle diameter of the thermally conductive particles. The “particle diameter” in this case is the equivalent spherical diameter by volume. In addition, since the second insulating inorganic particles are bonded to the thermally conductive particles and are merely a part of the composite particles, the contact area with the polyurethane foam of the base material is small, and the influence on the polyurethane foam is small. Therefore, the median diameter of the second insulating inorganic particles may be 1 μm or more and 20 μm or less.

The shape of the second insulating inorganic particles is not particularly limited. For example, in the case of the second insulating inorganic particles having a flat shape, the distance between the adjacent thermally conductive particles can be shortened compared to the case of a spherical shape. Therefore, the thermal conductivity between the adjacent composite particles is less likely to be inhibited. In addition, the contact area with the thermally conductive particles becomes large, making the second insulating inorganic particles less likely to peel off.

The content of the composite particles may be determined in consideration of thermal conductivity, influence on the foaming and curing reaction of the polyurethane foam, moldability, and the like. In order to achieve desired thermal conductivity, it is desirable that the content of the composite particles be 5 volume % or more in the case of the volume of the urethane foam molded body being 100 volume %. It is more suitable to be 10 volume % or more. On the other hand, from the viewpoint of not inhibiting the foaming and curing reaction and improving moldability, it is desirable that the content of the composite particles be 50 volume % or less. It is more suitable to be 20 volume % or less.

### [First Insulating Inorganic Particles]

The type of the first insulating inorganic particles dispersed in the base material may be the same as or different from the second insulating inorganic particles added as constituent particles of the composite particles. The shape of the first insulating inorganic particles is not particularly limited and may be spherical or flake-shaped. The first insulating inorganic particles may be one type or two or more types. For the first insulating inorganic particles as well, the aforementioned aluminum hydroxide, aluminum oxide, aluminum nitride, magnesium hydroxide, magnesium oxide, talc, calcium carbonate, clay, mica, silica, and the like are suitable. In addition, from the viewpoint of enhancing the thermal conductivity of the urethane foam molded body, those having relatively high thermal conductivity are desirable. For example, it is suitable that the thermal conductivity of the first insulating inorganic particles is 5 W/m·K or higher. Among these, aluminum hydroxide is suitable because aluminum hydroxide also has flame retardancy.

The first insulating inorganic particles have large diameter particles with a median diameter of 55 μm or more and 200 μm or less. In the case of the median diameter being 55 μm or more, the contact area with the polyurethane foam of the base material becomes small, and the influence of the first insulating inorganic particles on the polyurethane foam becomes small. For example, in the case of the large diameter particles being particles that react with water and exhibit alkalinity (alkaline inorganic particles), deterioration due to hydrolysis of the polyurethane is suppressed, and even in the case of the urethane foam molded body being placed under high temperature, physical properties such as elongation are less likely to deteriorate. On the other hand, in the case of the median diameter being 200 μm or less, the influence on moldability is small, and the occurrence of cracks and the like is suppressed. From the viewpoint of further improving moldability and normal state physical properties, the median diameter of the large diameter particles is preferably 150 μm or less. The first insulating inorganic particles may be composed of merely large diameter particles, or may be composed including particles other than large diameter particles if desired heat resistance and moldability can be achieved.

The content of the first insulating inorganic particles is desirably 20 volume % or less in the case of the volume of the urethane foam molded body being 100 volume %, considering the influence on the foaming and curing reaction of the polyurethane foam, moldability, and the like. It is more suitable to be 15 volume % or less. In addition, in order to obtain desired effects such as imparting electrical insulation and improving thermal conductivity, 5 volume % or more is desirable. It is more suitable to be 8 volume % or more.

### <Method for Manufacturing Urethane Foam Molded Body>

The method for manufacturing the urethane foam molded body of the disclosure is not particularly limited. As one form of a suitable manufacturing method, the method for manufacturing the urethane foam molded body of the disclosure includes a composite particle manufacturing process, a mixed raw material manufacturing process, and a foam molding process. Each of the processes is described below.

### [Composite Particle Manufacturing Process]

This process is a process for manufacturing composite particles by stirring a granulation raw material having powder of thermally conductive particles, powder of magnetic particles, powder of second insulating inorganic particles blended as needed, a binder, and water. The blending amount of the powder and binder to be used may be appropriately adjusted considering the magnetic field orientation of the composite particles, the electrical insulation of the urethane foam molded body, the thermal conductivity, and the like.

The blending amount of the powder of magnetic particles is desirably 20 parts by mass or more with respect to 100 parts by mass of the powder of thermally conductive particles, considering the magnetic field orientation of the composite particles. On the other hand, considering cost and weight reduction, it is desirably 130 parts by mass or less. 100 parts by mass or less, and further 80 parts by mass or less is more suitable. The blending amount of the binder is desirably 2 mass % or more in the case of the total mass of the powder to be bonded being 100 mass %, as a needed and sufficient amount for bonding the particles. On the other hand, in the case of the binder being excessive, the composite particles may aggregate with each other. For this reason, the blending amount of the binder is desirably 10 mass % or less. 5 mass % or less is more suitable. The binder may be solid or liquid. In the case of using water-soluble powder as the binder, it is preferable to stir the binder and other powder raw materials in advance, and then add water. By doing so, aggregation of particles can be suppressed.

In the case of including the powder of second insulating inorganic particles in the granulation raw material and disposing the second insulating inorganic particles in the outermost layer of the composite particles, this process may be configured to include a first stirring process of stirring a first raw material having powder of thermally conductive particles, powder of magnetic particles, a binder, and water, and a second stirring process of adding powder of second insulating inorganic particles to the stirred material of the first raw material and further stirring.

### [Mixed Raw Material Manufacturing Process]

This process is a process for manufacturing a mixed raw material by mixing powder of composite particles manufactured in the previous process, powder of first insulating inorganic particles, and a foamed urethane resin raw material.

As described above, the foamed urethane resin raw material may be prepared from raw materials such as polyol, polyisocyanate, catalyst, foaming agent, and foam stabilizer. The mixed raw material can be manufactured, for example, by mechanically stirring the powder of composite particles, powder of first insulating inorganic particles, and foamed urethane resin raw material using stirring blades or the like. Alternatively, the powder of composite particles and the powder of first insulating inorganic particles may be added to at least one of two components of the foamed urethane resin raw material (polyol raw material, polyisocyanate raw material) to prepare two types of raw materials, and then both raw materials may be mixed for manufacturing.

### [Foam Molding Process]

This process is a process of injecting the mixed raw material manufactured in the previous process into a cavity of a foam mold and performing foam molding while applying a magnetic field so that the magnetic flux density in the cavity becomes substantially uniform.

The magnetic field may be formed in a direction that orients the composite particles. For example, in the case of orienting the composite particles in a linear manner, it is desirable to form the magnetic field lines in the cavity of the foam mold to be substantially parallel from one end of the cavity toward the other end. To form such a magnetic field, for example, magnets may be disposed near both surfaces at one end and the other end of the foam mold so as to sandwich the foam mold. Permanent magnets or electromagnets may be used as the magnets. Using electromagnets allows instantaneous switching of magnetic field formation on and off, and facilitates control of magnetic field strength. Therefore, foam molding is easy to control. Additionally, it is desirable that the magnetic field lines constituting the magnetic field form a closed loop. By doing so, leakage of the magnetic field lines is suppressed, and a stable magnetic field can be formed in the cavity.

In this process, the magnetic field is formed so that the magnetic flux density in the cavity becomes substantially uniform. For example, it is preferable that the difference in the magnetic flux density in the cavity is within ±10%. It is more suitable to be within ±5%, and even more suitable within ±3%. By forming a uniform magnetic field in the cavity of the foam mold, uneven distribution of the composite particles can be suppressed, and a desired orientation state can be obtained. Additionally, foam molding is preferably performed at the magnetic flux density of 150 mT or higher and 350 mT or lower. By doing so, the composite particles in the mixed raw material can be reliably oriented. It is desirable that the magnetic field is applied while the viscosity of the foamed urethane resin raw material is relatively low. In the case of applying a magnetic field according to the foamed urethane resin raw material thickening and foam molding being completed to some extent, the composite particles are difficult to orient, making it difficult to obtain desired thermal conductivity. Note that it is not needed to apply a magnetic field during the entire time of performing foam molding.

After foam molding is completed in the process, demolding is performed to obtain the urethane foam molded body of the disclosure. At this time, depending on the foam molding method, a skin layer is formed on at least one of one end and the other end of the urethane foam molded body. The skin layer may be cut off according to the application (of course, the skin layer does not need to be cut off).

### EXAMPLE

Next, the disclosure will be described more specifically by giving examples. In the examples, urethane foam molded bodies were manufactured using several first insulating inorganic particles having different median diameters, and characteristics thereof were evaluated.

### <Manufacturing of Composite Particles>

Composite particles were manufactured by stirring granulation raw materials having expanded graphite powder as thermally conductive particles, stainless steel powder as magnetic particles, starch powder as a binder, talc powder as second insulating inorganic particles, and water. First, 1000 parts by mass of expanded graphite powder, 600 parts by mass of stainless steel powder, and 100 parts by mass of starch powder were charged into a container of a high-speed stirring type mixing granulator and mixed by blade stirring, and further 400 parts by mass of water was added and mixed for 1 minute. Next, 400 parts by mass of talc powder was charged and mixed for an additional 4 minutes. The stirring speed was 400 rpm. The obtained powder was dried to obtain composite particle powder. Details of the materials used are shown in the following (a) to (d).

### (a) Thermally Conductive Particles

Expanded graphite powder: “SYZR 502FP” manufactured by Shijiazhuang Aideite Trading Co., Ltd., particle size 300 μm˜: 80% or higher.

### (b) Magnetic Particles

Stainless steel powder: “AKT” manufactured by Mitsubishi Steel Mfg. Co., Ltd., median diameter 8.5 to 13.0 μm.

### (c) Binder

Starch powder: “Instant Tender Gel C” manufactured by Nippon Corn Starch Co., Ltd.

### (d) Second Insulating Inorganic Particles

Talc powder: “Micro Ace (registered trademark) K-1” manufactured by Nippon Talc Co., Ltd., median diameter 8 μm.

### <Manufacturing of Urethane Foam Molded Body>

A urethane foam molded body was manufactured using the powder of the manufactured composite particles and the powder of the first insulating inorganic particles. First, 100 parts by mass of polyether polyol (“SBU (registered trademark) Polyol 0248” manufactured by Sumika Covestro Urethane Co., Ltd.), 2 parts by mass of chain extender diethylene glycol (manufactured by Mitsubishi Chemical Corporation), 2 parts by mass of foaming agent water, 1.5 parts by mass of a tetraethylenediamine-based catalyst (“Kaolizer (registered trademark) No. 31” manufactured by Kao Corporation), and 0.5 parts by mass of a silicone-based foam stabilizer (“SZ-1333” manufactured by Toray Dow Corning Co., Ltd.) were mixed to prepare a polyol raw material. Additionally, a diphenylmethane diisocyanate (MDI) modified product was prepared as the polyisocyanate raw material. The MDI modified product was manufactured by mixing polyether polyol (same as above) and 4,4′-diphenylmethane diisocyanate (“Millionate MT” manufactured by Tosoh Corporation) so that the isocyanate (NCO) content became 70% by mass, and reacting at 100° C. for 180 minutes under nitrogen purge. Next, 80 parts by mass of the powder of composite particles and 60 parts by mass of the powder of first insulating inorganic particles were added to and mixed with 100 parts by mass of the polyol raw material to prepare premix polyol. Subsequently, 100 parts by mass of premix polyol and 10 parts by mass of the polyisocyanate raw material (MDI modified product) were mixed to form a mixed raw material.

The powder of first insulating inorganic particles used includes the following six types (A) to (F). Among these, the thermal conductivity of aluminum hydroxide powder (A), (C), and (D) is 8 W/m·K, the thermal conductivity of magnesium oxide powder (B) is 45 to 60 W/m·K, and the thermal conductivity of aluminum oxide powder (E) and (F) is 20 to 35 W/m·K. The median diameter of each of the powder was measured using a laser diffraction/scattering particle size distribution analyzer (“Microtrac MT3000EX-II” manufactured by MicrotracBEL Corp.). The powder (C) to (E) are included in the concept of “large diameter particles” in the disclosure. Additionally, when 2 g of each of the powder was dispersed in 50 mL of ion-exchanged water at room temperature and the pH of the dispersion after 5 minutes was measured with a glass electrode pH meter, the pH of aluminum hydroxide powder (A), (C), and (D) was 8, the pH of magnesium oxide powder (B) was 10, and the pH of aluminum oxide powder (E) and (F) was 7.
(A) Aluminum hydroxide powder: “B143” manufactured by Nippon Light Metal Co., Ltd., median diameter 2 μm.
(B) Magnesium oxide powder: “Pyroxyma (registered trademark) 3020” manufactured by Kyowa Chemical Industry Co., Ltd., median diameter 20 μm.
(C) Aluminum hydroxide powder: “SB53” manufactured by Nippon Light Metal Co., Ltd., median diameter 55 μm.
(D) Aluminum hydroxide powder: “SB93” manufactured by Nippon Light Metal Co., Ltd., median diameter 105 μm.
(E) Aluminum oxide powder: Ball mill pulverized product of “Sakurundum (registered trademark) 40SH” manufactured by Nippon Carlit Co., Ltd., median diameter 200 μm.
(F) Aluminum oxide powder: “Sakurundum (registered trademark) 40SH” manufactured by Nippon Carlit Co., Ltd., median diameter 300 μm.

Then, the mixed raw material was injected into an aluminum foam mold (cavity is a rectangular parallelepiped of 130 mm length×130 mm width×5 mm thickness), and the foam mold was sealed. The foam mold was then disposed in a magnetic induction foam molding apparatus to perform foam molding. In the cavity of the foam mold, a uniform magnetic field is formed by substantially parallel magnetic field lines from top to bottom. The magnetic flux density in the cavity is 200 mT, and the difference in magnetic flux density within the cavity is within ±3%. Foam molding was performed with a magnetic field applied for the first 2 minutes, followed by approximately 5 minutes without applying a magnetic field. After foam molding was completed, demolding was performed to obtain a urethane foam molded body. The obtained urethane foam molded bodies are referred to as urethane foam molded bodies A to F corresponding to the types of first insulating inorganic particles used. The content of composite particles in urethane foam molded bodies A to F is 7.5 volume %, and the content of first insulating inorganic particles is 12.5 volume % (both based on 100 volume % of the urethane foam molded body volume). Urethane foam molded bodies C, D, and E are included in the concept of the urethane foam molded body of the disclosure.

### <Evaluation of Urethane Foam Molded Body>

The thermal conductivity, elongation, heat resistance, and flame retardancy of the manufactured urethane foam molded body were evaluated. The evaluation results are collectively shown in Table 1 below. The evaluation methods are as follows.

### [Thermal Conductivity]

The thermal conductivity of the urethane foam molded body was measured using “HC-110” manufactured by EKO Instruments Co., Ltd. in accordance with the heat flow meter method of JIS A1412-2:1999.

### [Elongation]

Five dumbbell-shaped No. 1 test pieces specified in JIS K 6251:2017 were prepared from the urethane foam molded body, and for each of the test pieces, a tensile test specified in the same JIS was performed at a tensile speed of 200 mm/min to calculate the elongation at break (Eb). The normal state physical properties were evaluated as extremely good (indicated by ∘ in Table 1 below) in the case where the elongation at break of all test pieces was 50% or more, good (indicated by Δ in the same table) if not all but at least one test piece had an elongation at break of 50% or more, and poor (indicated by x in the same table) in the case where the elongation at break of all test pieces was less than 50%.

### [Heat Resistance]

Dumbbell-shaped No. 1 test pieces were prepared in the same manner as in the elongation evaluation above, and they were placed in an oven adjusted to 150° C. and held for 400 hours. After returning the test pieces to room temperature, a tensile test was performed under the same conditions as in the elongation evaluation above, and the elongation at break (Eb) was calculated. The heat resistance was evaluated as extremely good (indicated by ∘ in Table 1 below) in the case where the elongation at break of all test pieces was 30% or more, good (indicated by Δ in the same table) if not all but at least one test piece had an elongation at break of 30% or more, and poor (indicated by x in the same table) in the case where the elongation at break of all test pieces was less than 30%.

### [Flame Retardancy]

A vertical burning test according to UL94 standard was conducted. In the vertical burning test, a gas burner flame is applied to the lower end of a vertically held sample for 10 seconds. In the case where combustion stops within 30 seconds, the flame is applied for another 10 seconds. The V-O level is determined in the case where all of the following five criteria are satisfied. (1) The sample does not burn for longer than 10 seconds in either of the two flame applications. (2) The total combustion time from the two flame applications each for five samples does not exceed 50 seconds. (3) No sample burns up to the position of the fixing clamp. (4) No sample drops burning particles that ignite cotton placed below the sample. (5) After the second flame application, the sample does not continue glowing for longer than 30 seconds.

TABLE 1

| Urethane foam molded body | | | A | B | C | D | E | F |
|---|---|---|---|---|---|---|---|---|
| Median diameter of first insulating inorganic | | | 2 μm | 20 μm | 55 μm | 105 μm | 200 μm | 300 μm |
| particles (D₅₀) | | | | | | | | |
| First | Aluminum | (A) median | 60 | — | — | — | — | — |
| insulating | hydroxide | diameter 2 μm | | | | | | |
| inorganic | (pH 8) | (C) median | — | — | 60 | — | — | — |
| particles | | diameter 55 μm | | | | | | |
| [part by | | (D) median | — | — | — | 60 | — | — |
| mass] | | diameter 105 μm | | | | | | |
| | Magnesium | (B) median | — | 60 | — | — | — | — |
| | oxide (pH 10) | diameter 20 μm | | | | | | |
| | Aluminum | (E) median | — | — | — | — | 60 | — |
| | oxide (pH 7) | diameter 200 μm | | | | | | |
| | | (F) median | — | — | — | — | — | 60 |
| | | diameter 300 μm | | | | | | |

| Composite particles [part by mass] | | 80 | 80 | 80 | 80 | 80 | 80 |
|---|---|---|---|---|---|---|---|
| Content of first insulating inorganic particles | | 12.5 | 12.5 | 12.5 | 12.5 | 12.5 | 12.5 |
| [volume %] | | | | | | | |
| Content of composite particles [volume %] | | 7.5 | 7.5 | 7.5 | 7.5 | 7.5 | 7.5 |
| Evaluation | Thermal conductivity [W/m · K] | 0.7 | 0.7 | 0.7 | 0.7 | 0.8 | 0.8 |
| results | Normal state physical properties | ◯ | ◯ | ◯ | ◯ | Δ | X |
| | (elongation) | | | | | | |
| | Heat resistance (elongation after | X | X | ◯ | ◯ | Δ | X |
| | being held 400 hours at 150° C.) | | | | | | |
| | Flame retardancy (UL94 | V-0 | V-0 | V-0 | V-0 | V-0 | V-0 |
| | standard) | | | | | | |

As shown in Table 1, urethane foam molded bodies C to E have large diameter particles as the first insulating inorganic particles. Therefore, the normal state physical properties and heat resistance were good. In urethane foam molded body E, the median diameter of the first insulating inorganic particles is larger compared to urethane foam molded bodies C and D. Therefore, slight cracks occurred, and the normal state physical properties and heat resistance were somewhat reduced. Moreover, the thermal conductivity of urethane foam molded bodies C to E was large at 0.7 W/m·K or higher, and the flame retardancy was also V-0. From the above, it was confirmed that urethane foam molded bodies C to E satisfy thermal conductivity, heat resistance, and flame retardancy.

In contrast, urethane foam molded bodies A and B, which do not have large diameter particles as first insulating inorganic particles and have a median diameter of the first insulating inorganic particles of 20 μm or less, satisfied thermal conductivity, normal state physical properties, and flame retardancy, but resulted in inferior heat resistance. Moreover, urethane foam molded body F, which does not have large diameter particles as first insulating inorganic particles and has a median diameter of the first insulating inorganic particles of 300 μm, satisfied thermal conductivity and flame retardancy, but resulted in inferior normal state physical properties and heat resistance due to reduced moldability caused by crack generation and the like.

The urethane foam molded body of the disclosure is suitable as a sound insulation material used in vehicle parts such as battery covers, electric powertrain (eAxel) covers, seat motor covers, under covers, floor mats, dash silencers, hood silencers, various ECUs, junction boxes, and electronic devices such as personal computers.

What is claimed is:

1. A urethane foam molded body, comprising:
a base material, made of polyurethane foam; composite particles, contained in an oriented manner in the base material; and first insulating inorganic particles, dispersed in the base material,
the composite particles comprising thermally conductive particles and magnetic particles bonded to a surface of the thermally conductive particles by a binder, and
the first insulating inorganic particles comprising large diameter particles having a median diameter of 55 μm or more and 200 μm or less.

2. The urethane foam molded body according to claim 1, wherein a content of the first insulating inorganic particles is 5 volume % or more and 20 volume % or less in the case of a volume of the urethane foam molded body being 100 volume %.

3. The urethane foam molded body according to claim 1, wherein thermal conductivity of the first insulating inorganic particles is 5 W/m·K or higher.

4. The urethane foam molded body according to claim 1, wherein the first insulating inorganic particles comprise one or more types selected from aluminum hydroxide, aluminum oxide, aluminum nitride, magnesium hydroxide, magnesium oxide, talc, calcium carbonate, clay, mica, and silica.

5. The urethane foam molded body according to claim 1, wherein the large diameter particles are particles that react with water to exhibit alkalinity.

6. The urethane foam molded body according to claim 1, wherein the thermally conductive particles comprise expanded graphite particles.

7. The urethane foam molded body according to claim 1, wherein the composite particles comprise second insulating inorganic particles bonded to a surface of the thermally conductive particles by a binder.

8. The urethane foam molded body according to claim 7, wherein a particle diameter of the second insulating inorganic particles is 1/10 or less of a particle diameter of the thermally conductive particles, and a median diameter is 1 μm or more and 20 μm or less.

9. The urethane foam molded body according to claim 7, wherein the second insulating inorganic particles comprise one or more types selected from aluminum hydroxide, aluminum oxide, aluminum nitride, magnesium hydroxide, magnesium oxide, talc, calcium carbonate, clay, mica, and silica.
